(19) United States
(12) Patent Application Publication
(10) Pub. No.: US 2007/0011316 A1
(43) Pub. Date: Jan. 11, 2007

(54) Contents viewing system, contents viewing method, and computer program product

(76) Inventors: Tadashi Araki, Kanagawa (JP); Ai Kato, Kanagawa (JP); Zoran Stejic, Tokyo (JP); Yasushi Ogawa, Kanagawa (JP); Hisashi Miyamori, Tokyo (JP); Mitsuru Minakuchi, Tokyo (JP); Katsumi Tanaka, Tokyo (JP)

Correspondence Address: DICKSTEIN SHAPIRO LLP, 1825 EYE STREET NW, Washington, DC, 20006-5403, US

(21) Appl. No.: 11/475,045

(22) Filed: Jun. 27, 2006

(30) Foreign Application Priority Data
Jul. 8, 2005 (JP) 2005-200216

(51) Int. Cl. G06F 15/173

(52) U.S. Cl. 709/224

(57) ABSTRACT

A display controller reads an object, which is an intended zoom object, and changes its display form, generating a revised contents organization and displaying the revised contents organization on a display unit, based on an operation content of a user retrieved by an operation retrieving unit, an organization description pertaining to a display aspect of the contents, and a zoom description that describes the zoom action/behavior of each zoom object. Consequently, editing the contents becomes much easier. Further, the user is ensured a fair degree of freedom for viewing the contents.

### CROSS-REFERENCE TO RELATED APPLICATIONS

The present document incorporates by reference the entire contents of Japanese priority document, 2005-200216 filed in Japan on Jul. 8, 2005.

### BACKGROUND OF THE INVENTION

1. Field of the Invention

The present invention relates to a technology for viewing contents.

2. Description of the Related Art

With the prevalence of camera mobile phones and digital video cameras, office documents (such as reports, conference minutes, memos, etc.) have come to include multimedia contents, constituting a collection of different kinds of media objects (such as text, still images, video images, etc.).

However, the currently available browsers for viewing or editing the multimedia contents of an office document have various drawbacks.

The first disadvantage is that the screen organization is not very flexible. More specifically, all the objects are contained on a single page, leading to poor viewability. Further, the inflexibility of screen organization makes it difficult for controlling the resolution of the media and balancing the display between different media (such as text media and a related image) according to a user's preference or viewing device being used.

The second disadvantage is that linked data are displayed on different pages. More specifically, objects linked by hyperlinks are displayed on different pages, making it difficult to locate the target portion in the whole document and shrouding the context of browsing.

The third disadvantage is that editing and creating documents become time-consuming processes. More specifically, when creating content, layout within a page, display size, etc. have to be detailed out. Further, link sources and link destinations also need to be created.

To partially solve the problems described above, Japanese Patent Laid-Open Publication No. 2000-172248, Japanese Patent Laid-Open Publication No. 2003-76718, and Japanese Patent Laid-Open Publication No. 2003-330856 have disclosed utilization of zooming media.

Japanese Patent Laid-Open Publication No. 2000-172248 discloses an electronic data display method in which a group of electronic documents having a hypertext composition is arranged in a single virtual space based on the link organization. Based on the view defined in the virtual space, display images for browsing the electronic documents are created and displayed on a display device. The view is changed continually in the virtual space according to the user's specification, the display image based on the current view is created continually in real time, and output to the display device. This enables the user to view the document by following the hypertext links, continually zooming in on the document.

Japanese Patent Laid-Open Publication No. 2003-76718 discloses a contents viewing system that includes a building unit that builds electronic data contents (hereinafter, contents), a profile creating unit that creates content profile to be used during content search, and a map placement determining unit that places thumbnails including therein link data that point to the content, based on the content profile created by the profile creating unit. The contents viewing system disclosed in Japanese Patent Laid-Open Publication No. 2003-76718 also includes a map exploring unit, a filtering unit, and a display unit, wherein the map exploring unit is equipped with functions such as zoom in, zoom out, panning, etc., the filtering unit that displays the thumbnail matching specific conditions on the map, and the display unit displays the overview and details of the contents when the user clicks the thumbnail. This contents viewing system allows the user to view the overview and details of the electronic data by exploring the data space using an image.

Japanese Patent Laid-Open Publication No. 2003-330856 discloses a browser system in which a zoom status determining unit determines the zoom status based on the input received by an input device, a contents layout creating unit creates a contents layout according to the determined zoom status, a meta data layout creating unit dynamically creates a meta-data layout based on the zoom status and the contents layout, and a, display unit displays by superposing the contents layout, the meta data layout, and a pointer. In this browser system, consistency between the contents layout and the meta data layout can be preserved even if the contents layout is dynamic.

However, the electronic data display method disclosed in Japanese Patent Laid-Open Publication No. 2000-172248 mainly concerns itself with browsing hypertext within a 3D virtual space, wherein by zooming in on a particular electronic data, another electronic data linked to that electronic data is displayed in a predetermined zoom status. However, no other zooming method is cited. Therefore, the electronic data display method is poor in terms of flexibility in the display method.

The contents viewing system disclosed in Japanese Patent Laid-Open Publication No. 2003-76718 uses a zooming metaphor for viewing 2D planar content thumbnails. However, only thumbnails and content keywords are displayed and no consideration is given to zooming of a wide range of objects.

The browser system disclosed in Japanese Patent Laid-Open Publication No. 2003-330856 defines two types of layouts, namely, the contents layout and the meta data layout, and implements the zooming metaphor on these. However, this entails segregating data into contents and meta data beforehand, making it a time-consuming operation.

### SUMMARY OF THE INVENTION

It is an object of the present invention to at least partially solve the problems in the conventional technology.

According to an aspect of the present invention, a contents viewing system includes a zoom-object storing unit that stores objects in a storage unit, the objects being potential zoom objects and constituent elements of contents, and the contents being elements of data; a contents storing unit that stores an organization description and a zoom description in the storage unit, wherein the organization description pertains to a display aspect-of the contents, and the zoom description distinguishes between the zoom objects and non-zoom objects, and describes zoom action/behavior for each of the zoom objects, the zoom description being independent from the organization description; an operation retrieving unit that retrieves operation content; and a display control unit that reads zoom object from the storage unit based on retrieved operation contents, the organization description and the zoom description in the storage unit, changes a display form of read zoom object to obtain contents to be displayed, and displays the contents to be displayed on a display unit.

According to another aspect of the present invention, a contents viewing method includes storing objects in a storage unit, the objects being potential zoom objects and constituent elements of contents, and the contents being elements of data; storing an organization description and a zoom description in the storage unit, wherein the organization description pertains to a display aspect of the contents, and the zoom description distinguishes between the zoom objects and non-zoom objects, and describes zoom action/behavior for each of the zoom objects, the zoom description being independent from the organization description; retrieving operation content; reading zoom object from the storage unit based on retrieved operation contents, the organization description and the zoom description in the storage unit; and changing a display form of read zoom object to obtain contents to be displayed, and displays the contents to be displayed on a display unit.

According to still another aspect of the present invention, a computer program product includes computer program codes that causes a computer to implement the above method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic of a contents viewing system according to a first embodiment of the present invention;

FIG. 2 is a block diagram of a typical personal computer that can be employed in the contents viewing system shown in FIG. 1;

FIG. 3 is a functional block diagram of a contents storing process of a server computer and a contents viewing process of a client computer shown in FIG. 1;

FIG. 4 is a schematic for explaining screen transition that takes place when viewing multimedia contents;

FIG. 5 is a example of display of multimedia contents according to a second embodiment of the present invention;

FIG. 6 is a schematic of a result of zoom-in action on Object A of the multimedia contents shown in FIG. 5;

FIG. 7 is a result of a zoom-in action on Object A of the multimedia contents shown in FIG. 6;

FIG. 8 is a schematic for explaining a screen transition according to a third embodiment of the present invention; and

FIG. 9 is a flowchart of a path selecting process.

### DETAILED DESCRIPTION OF THE PREFERRED EMBODIMENTS

Exemplary embodiments of the present invention are explained next with reference to the accompanying drawings.

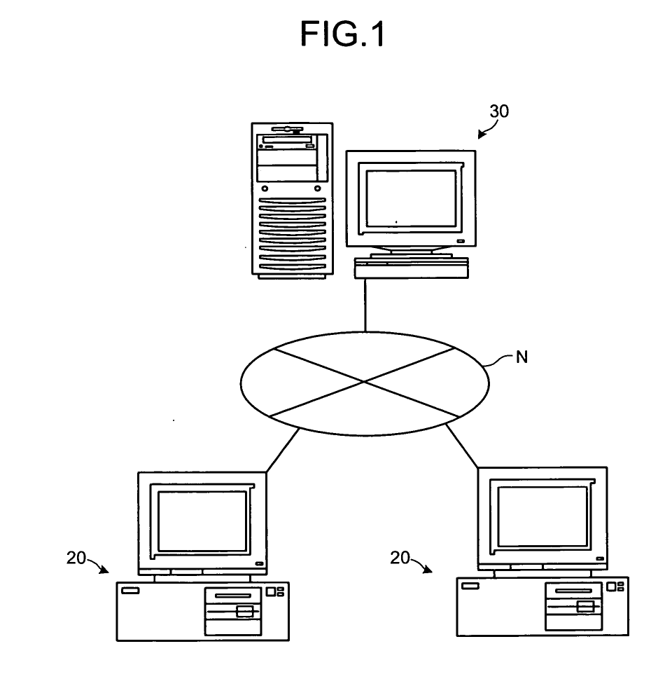

A first embodiment of the present invention is explained next with reference to FIG. 1 through FIG. 8. FIG. 1 is a schematic of a contents viewing system according to the first embodiment of the present invention. The contents viewing system according to the first embodiment includes a plurality of client computers 20 connected to a server computer (contents server) 30 via a network N such as a local area network (LAN). The server computer 30 provides services to the client computers 20. Each of the client computer 20 is operated by a user to enjoy the services provided by the server computer 30. The server computer 30 and the client computers 20 can be typical personal computers.

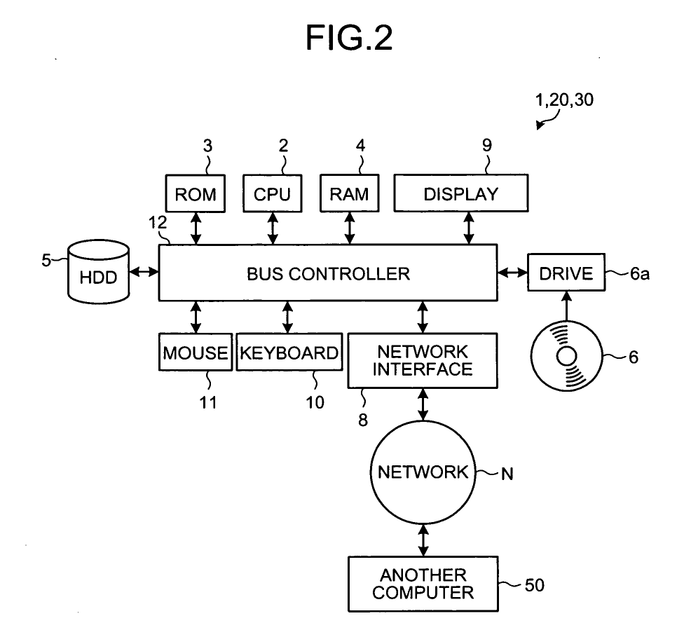

FIG. 2 is a block diagram of a typical personal computer 1 that can be used as the server computer 30 or the client computers 20. The personal computer (hereinafter, “computer”) 1 includes a central processing unit (CPU) 2 that processes information, a read-only memory (ROM) 3 that stores Basic Input Output System (BIOS), etc., a primary storage device such as a random access memory (RAM) 4 that temporarily stores information while it is being processed, a secondary storage device such as a hard disk drive (HDD) 5 that functions as a storage unit for storing therein application programs, process results, etc., a drive 6a of a storage medium such as a removable media 6 that archives information on an external device or distributes information to the external device or acquires information (application data, etc.) from the external device, a network interface 8 that is connected to the network N to facilitate communication between the computer 1 and some other external computer 50, a display unit 9 that displays progress of various processes, process results, etc., and an input unit such as a keyboard 10 or a mouse 11 by which the user can input commands, data, etc. to the computer 1. A bus controller 12 controls data communication between the parts mentioned above.

Different kinds of storage medium, such as an electromagnetic storage medium, optical storage medium, or semiconductor memory, etc. can be used as the removable media 6. Flexible disks, hard disks, magnetic tapes, etc, are some examples of electromagnetic storage medium. Compact disk (CD), compact disk-Read-only memory (CD-ROM), compact disk-Recordable (CD-R), compact disk-Rewritable (CD-RW), digital versatile disk-Read-only memory (DVD-ROM), Digital versatile disk-Recordable (DVD-R), Digital versatile disk-Random access memory (DVD-RAM), Digital versatile disk-Rewritable (DVD-RW), DVD+ROM drive (DVD+RD), etc., are some examples of optical storage medium.

Data transmission takes place by the computer 1 sending the data to the network interface 8 and the network interface 8 outputting signals to the network N. When receiving the signals, the network interface 8 determines whether the data is required. If the data is required, the data is retrieved. Otherwise it is destroyed. In other words, both data transmission and reception take place via the network interface 8.

Typically, when the user boots the computer 1, the CPU 2 launches a computer program called loader residing in the BIOS stored in the ROM 3, and loads a program called an operating system (OS) from the HDD to the RAM 45. The OS is a computer program that manages the hardware and software of the computer 1. Once the OS is launched, application programs can be started up, data can be read, saved, etc. Windows (Registered Trademark of Microsoft Corporation), UNIX (Registered Trademark of X/Open, Inc.), etc. are well-known examples of OS. The programs that run under these OS are called application programs. Application programs are not just computer programs that run under an OS but can also be computer programs, described later, that assign execution of various processes partially to the OS or some computer programs of a program file containing a group of programs of an application software, OS, etc.

Typically, an application program is recorded on the removable media 6 from where it is installed on the HDD 5 of the computer 1. Thus, the removable media 6 also functions as a storage media for the application program. The application program can also be retrieved from an external device via the network interface 8 and installed on the HDD 5.

When an application program is launched on the computer 1 (which can be the server computer 30 or the client computers 20), the CPU 2 performs various computations and controls each part according to the application program.

A process, performed by the CPU 2 of the computer 1, and which is characteristic of the present embodiment, is described next. In short, according to the present embodiment, when only the text portion out of the multimedia content (report, conference minutes, memo, etc.) on the initial screen is zoomed, the text object can be viewed in further detail along with a picture/pictures of the participants of the meeting and audio/video recordings of the discussion.

The HDD 5 of the server computer 30 has stored therein an application program which is a contents storing program. In other words, when the server computer 30 launches the contents storing program, which runs under the OS of the server computer 30, the CPU 2 executes a contents storing process by controlling all the parts according to the contents storing program.

Similarly, the HDD 5 of the client computer 20 has stored therein an application program which is a contents viewing program. In other words, when the client computer 20 launches the contents viewing program, which runs under the OS of the client computer 20, the CPU 2 executes a contents viewing process by controlling all the parts according to the contents viewing program.

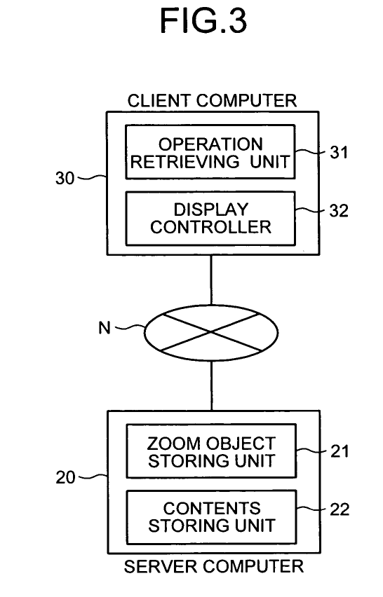

FIG. 3 is a functional block diagram of the contents storing process of the server computer 30 and the contents viewing process of the client computer 20. The CPU 2 of the server computer 30 implements a zoom-object storing unit 21 and a contents storing unit 22, according to the contents storing program running under the OS of the server computer 30. Similarly, the CPU 2 of the client computer 20 implements an operation retrieving unit 31 and a display controller 32, according to the contents viewing program running under the OS of the client computer 20.

The contents storing process of the server computer 30 is explained first.

The zoom-object storing unit 21 stores singly media objects (text, still images, video images, audio objects, etc.) that are combined to form multimedia contents. These media objects constitute contents and are intended zoom objects.

The contents storing unit 22 stores display descriptions (organization description and zoom description) of the multimedia content, wherein the description can have the following characteristics (see a through h). The organization description and zoom description are written in Extensible Markup Language (XML).

a. Zoom action/behavior of the zoom object can be described independent of the contents organization.

b. The zoom action/behavior for each object included in the contents can be described.

c. The zoom object can be distinguished from an object that is not intended to be zoomed.

d. Change in the resolution of the object and media transition can be described.

e. Zoom propagation between linked objects can be described.

f. Templates can be described.

A basic structure of the description language for realizing the above requirement items is explained next.

1. Zooming Operation of Zoom Object Singly

A zoom object is a single unit, which is subjected to a zoom action. A zoom object is composed of a single media object and can be a text media, a still image, video images, or an audio object. The tag <template/> denotes the template of the zoom object. The attribute “name” indicates the name of the template, and the attribute “match” indicates a reference position in the contents organization description of the media object. The media object is denoted by <text/>, <video/>, etc. The attribute “select” indicates a relative position to the media object from the reference position indicated by the attribute “match”. The user can perform-zoom action by specifying the desired zoom object (for example, by taking the cursor to the intended zoom object). However, no particular specification method is mentioned in the description language.

2. Control of Zoom Degree by Zoom Factor

Zoom factor refers to a value that indicates a zoom degree of the zoom object and can be any value between 0.0 to 1.0. The attribute ZoomFactor is used to specify zoom factor. The display status of each media object according to the zoom factor is described using the tags <dispText>, <dispImg>, <dispVideo>, and <dispAudio>. This enables description of change in the resolution of the media object and media transition (see example presented later). The attribute initZoomFactor in the <template/> tag indicates the initial zoom factor when the contents are initially displayed. The zoom factor is determined by the operation the user performs on the zoom object (for example, when the degree of movement of the mouse and zoom factor are correlated). However, no particular operation method is mentioned in the description language.

3. Zoom Propagation between Linked Zoom Objects

Zoom propagation refers to when a zoom object is zoomed, another linked object is also zoomed simultaneously (for example, when a zoom object of a higher level is zoomed, the zoom object of a lower level is also simultaneously zoomed). Zoom propagation involves calculation of the zoom factor of the propagation destination zoom object from the zoom factor of the propagation source zoom object based on a zoom factor relation to control the display status of the propagation destination zoom object. Zoom factor relation is a value indicating the comparison between the rate of change of the zoom factor between the propagation source zoom object and the propagation destination zoom object (for example, if the zoom factor relation is set at 0.8, by changing the zoom factor of the propagation source zoom object by 0.5, the zoom factor of the propagation destination zoom object is changed by 0.4. The tag <propagation/> describes the zoom propagation behavior. The attribute “destination” refers to the template name of the propagation destination zoom object. The attribute “select” refers to the location of the media object included in the propagation destination zoom object in the organization description. The attribute “relation” refers to the comparison between the rate of change of the zoom factor between the propagation source zoom object and the propagation destination zoom object. For example, if the zoom factor relation is set at 0.8, by changing the zoom factor of the propagation source zoom object by 0.5, the zoom factor of the propagation destination zoom object is changed by 0.4. If the zoom factor relation is set at −0.5, by changing the zoom factor of the propagation source zoom object by 0.6, the zoom factor of the propagation destination zoom factor is changed by −0.3.

4. Correlation between Organization Description Using Xpath and Zoom Action/Behavior Description

The attribute “match” in the <template/> tag, the attribute “select” in the <text/> and <video/> tag, and the attribute “select” of the <propagation/> tag describe the relevant part of the organization description in Xpath. Xpath refers to XML Path Language and is a standard for the syntax indicating a specific portion of an XML document.

5. Display Status of Media Object

The tags <dispText>, <dispImg>, <dispVideo>, and <dispAudio> respectively refer to the display status of the text, still image, video image, and audio. The attribute zoomFactor indicates the zoom factor.

Example for text

<dispText zoomFactor=“0.5” fontSize=“10 pt”/>

(which means) Display text at a zoom factor of 0.5 and a font size of 10 points.

Example for still image

<dispimg zoomFactor=“0.2” imgSize=“10%/>

(which means) Display still image at a zoom factor of 0.2 and at 10% of the maximum size.

Example for video image

<dispVideo zoomFActor=“0.7” start=“0” end=“300” videoSize=“50%”/>

(which means) Display video image at a zoom factor of 0.7 and at 50% of the maximum size from frame 0 to frame 300.

Example for audio object

<dispAudio zoomFactor=“0.4” start=“0s” end=“30s”/>

(which means) Play audio object from start to 30 seconds at a zoom factor of 0.4.

The contents viewing process in the client computer 20 is described next.

An operation retrieving unit 31 of the client computer 20 retrieves the operation content of the user. For example, after specification of the zoom object, zoom action is performed by dragging the mouse 11. If the mouse 11 is dragged downward on the display screen the zoom object is zoomed in on and if the mouse 11 is dragged upward on the display screen, the zoom object is zoomed out.

A display controller 32 of the client computer 20 reads the media object (text, still image, video image, audio object, etc.) from the zoom-object storing unit 21, based-on the operation content of the user retrieved from the operation retrieving unit 31 and the display descriptions (organization description and zoom description) stored in the contents storing unit 22, sets the display status and the resolution, auto sets the display position of the media object, and controls the display of the boundary lines of the media object. More specifically, the display controller 32 sets the display status and the resolution of the media object on the display unit 9 by interpreting the display description (zoom description) stored in the contents storing unit 22 and performing zooming.

The content display on the display 6 based on the display descriptions (organization description and zoom description) is described next.

Examples of Simultaneous Media Transition and Change in Resolution

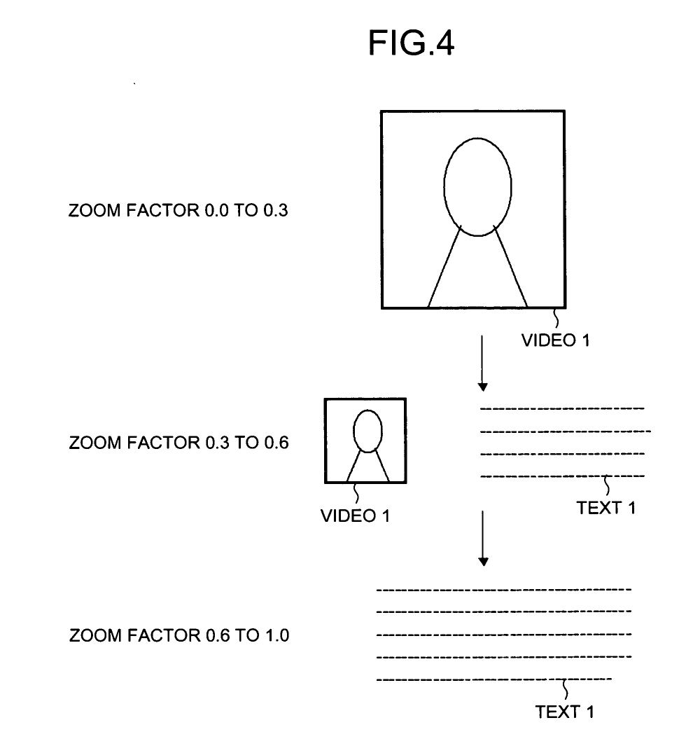

FIG. 4 is a schematic for explaining the screen transition that takes place when viewing multimedia contents. Up to a zoom factor of less than 0.3, only video 1 is displayed. Between zoom factors 0.3 and less than 0.6 both video 1 and text 1 are displayed, and from zoom factor 0.6 onwards only text 1 is displayed. The zoom description for the screen transition shown in FIG. 4 is given below.

```
Organization description of contents
<program>
<scene>
    <video href=“video1.mpg”/>
    <text href=“text1.txt”/>
</scene>
<scene>
    <video href=“video2.mpg”/>
    <text href=“text2.txt”/>
</scene>
.....
<program/>
Organization description of contents
<template name=“Scene1” match=“/program/scene[1]”
initZoomFactor=“0.0”>
  <video select=“video”>
    <dispVideo zoomFactor=“0.0” start=“0” end=“300”
videoSize=“100%”/>
    <dispVideo zoomFactor=“0.6” start=“0” end=“300”
videoSize=“0%”/>
  </video>
  <text select=“text”>
    <dispText zoomFactor=“0.3” fontSize=“0pt”/>
    <dispText zoomFactor=“0.5” fontSize=“12pt”/>
  </text>
</template>
```

In the zoom description, the reference position of a zoom object Scene1 is /program/scene[1] of the organization description and the initial zoom factor is 0.0. Scene1 includes video1.mpg and text1.txt which for the lower layer of /program/scene[1]. Up to a zoom factor of less than 0.3 only video 1 of Scene1 is displayed, between zoom factors 0.3 and less than 0.6 both video 1 and text 1 of Scene1 are displayed, and from zoom factor 0.6 onwards only text 1 of Sceen1 is displayed.

In the zoom description so far, a specific zoom object (Scene1) in the organization is specified. A common zoom action/behavior for all the scenes having a similar pattern can be described in a similar way. The zoom description for describing a plurality of scenes having a similar structure is given below.

Zoom description of contents

```
<template name=“Scene” match=“/program/scene”
initZoomFactor=“0.0”>
  <video select=“video”>
    <dispVideo zoomFactor=“0.0” start=“0” end=“300”
videoSize=“100%”/>
    <dispVideo zoomFactor=“0.6” start=“0” end=“300”
videoSize=“0%”/>
  </video>
  <text select=“text”>
    <dispText zoomFactor=“0.3” fontSize=“0pt”/>
    <dispText zoomFactor=“0.5” fontSize=“12pt”/>
  </text>
</template>
```

The difference between specifying a particular scene (for example, Scene1) and all scenes lies in the first line of the zoom description. In the case of a specific scene (for example, Scene 1), the <program/> tag contains scene[1], [1] specifying the scene. However, for applying a common zoom action/behavior to all the scenes having a similar structure, the <program/> tag contains just scene with no scene identifier. In other words, zoom action/behavior template can be described. That is, the same zoom action/behavior can be implemented on the <video/> and <text/> of all the <scene/> tags.

Apart from describing zoom action/behavior for a specific zoom object, a template can also be described for all the zoom objects having a similar structure.

Example of Zoom Propagation when Zoom Factor Relation is a Positive Value

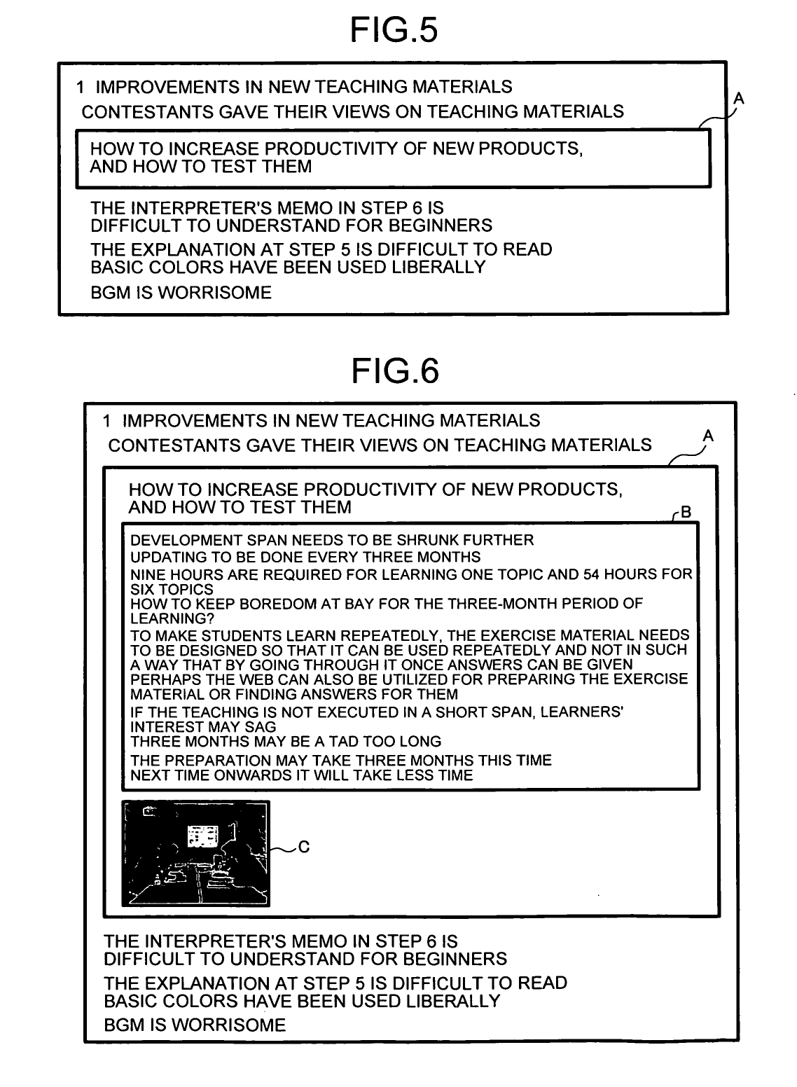

An example of zoom propagation when the zoom factor relation is a positive value is explained next. FIG. 5 through FIG. 7 are schematics for explaining the screen transition that takes place when viewing multimedia contents. FIG. 5 is an example of display of multimedia contents on the display unit 9. The multimedia contents in this example pertain to a business report. The multimedia contents of the business report are predominantly text.

FIG. 6 is a schematic of a result of a zoom-in action on Object A of the multimedia contents shown in FIG. 5. The result of zooming in on Object A reveals Object B below Object A, and Object C below Object B. Object C is a static video image of the discussion pertaining to Object A.

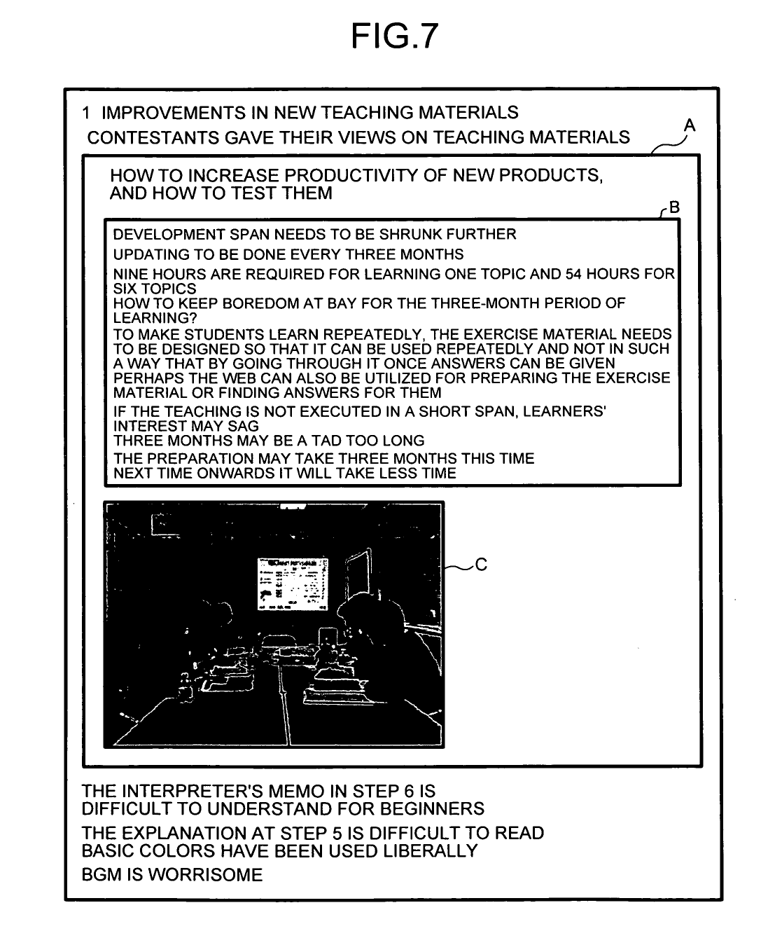

FIG. 7 is a schematic of a result of a zoom-in action on Object A of the multimedia contents shown in FIG. 6. Zooming in on Object A increases the font size of Object A and Object B. In addition, the resolution of the static video image of the Object C also becomes higher (that is, the image size increases). Further, the playback (with sound) of Object C start beyond a certain size.

The organization description and the zoom description of the screen transitions shown in FIG. 5 through FIG. 7 are given below.

```
Organization description of contents
  <report>
      <chapter>
        <title>1. Improvements in new teaching
materials</title>
        <sentence>Contestants gave their views on teaching
materials.</sentence>
        <section>
          <title>How to increase productivity of new
products, and how to
              test them (problem encountered)</title>
          <sentence>Development span needs to be shrunk
further.</sentence>
          <sentence>Updating to be done every three
months.</sentence>
            .......
          <video.href=“Meeting11.mpg”/>
        </section>
        <section>
          <title>The interpreter's memo in step 6 is
difficult to understand for beginners.</title>
            .......
        </section>
      </chapter>
        .......
    <report>
Zoom description of contents
<template name=“Chapter” match=“/chapter”
initZoomFactor=“0.0”>
  <text select=“title, sentence”>
    <dispText zoomFactor=“0.0” fontSize=“12pt”/>
    <dispText zoomFactor=“1.0” fontSize=“14pt”/>
  </text>
</template>
<template name=“Section” match=“/chapter/section”
initZoomFactor=“0.0”>
  <text select=“title”>
    <dispText zoomFactor=“0.0” fontSize=“11pt”/>
    <dispText zoomFactor=“1.0” fontSize=“11pt”/>
  </text>
</template>
<template name= “SecText” match=“/chapter/section”
initZoomFactor=“0.0”>
  <text select=“sentence”>
    <dispText zoomFactor=“0.1” fontSize=“8pt”/>
    <dispText zoomFactor=“1.0” fontSize=“10pt”/>
  </text>
</template>
<template name=“SecVideo” match=“/chapter/section”
initZoomFactor=“0.0”>
  <video select=“video”>
    <dispVideo zoomFactor=“0.1” start=“0” end=“0”
videoSize=“20%”/>
    <dispVideo zoomFactor=“0.4” start=“0” end=“900”
videoSize=“50%”/>
    <dispVideo zoomFactor=“1.0” start=“0” end=“900”
videoSize=“100%”/>
  </video>
</emplate>
<propagation source=“Chapter” select_s=“/chapter”
dest=“Section” select_d=“section
” relation=“0.8”/>
<propagation source=“Section” select_s=“/chapter/section”
dest=“SecText” select_d=
“.” relation=“0.8”/>
<propagation source=“Section”
select_s=“/chapter/section”dest=
“SecVideo” select_d=
“.” relation=“0.8”/>
```

In the zoom description, the zoom object Chapter includes <title/> and <sentence/> that is immediately below the <chapter/> in the organization description. Section includes <title/> that is immediately below the <section/> in the organization description. SecText includes <sentence/> that is immediately below the <section/>, and SecVideo includes <video/> that is immediately below the <section/>.

The initial zoom factor of all the zoom objects is 0.0. However, the text of the first two entities is displayed on the initial screen while the latter two entities are not displayed at all, as on the screen shown in FIG. 5.

The description <propagation source=“chapter” select_s=“/chapter” dest=“Section” select_d=“section” relation=“0.8/> indicates that if Chapter that corresponds to the reference position /chapter (source=“chapter” select_s=“/chapter”) is zoomed, zoom propagation is applied to the Section that corresponds to the section below the /chapter (dest=“Section” select_d=“section”). In other words, if a particular Chapter is zoomed, zoom propagation is applied only to the Section under the zoomed chapter and not to the Sections under other Chapters. The description “relation=” 0.8” refers to the zoom factor relation at which zoom propagation is applied to the Section.

Similarly, the descriptions <propagation source=“Section” select_s=“/chapter/section” dest=“SecText” select_d=“.” relation=“0.8”/> and <propagation source=“Section” select_s=“/chapter/section” dest=“SecVideo” select_d=“.” relation=“0.8”/> indicate zoom propagation is applied at a zoom factor relation of 0.8 to SecText and SecVideo, respectively, that correspond to the indicated positions.

To sum up, if a particular Chapter is zoomed, zoom propagation is applied to the Section under Chapter, and from the Section to SecText and SecVideo of the same location. In other words, the initial screen (FIG. 5) is zoomed in till the zoom factor of SecText and SecVideo reaches 0.1, when the <sentence/> and the <video/> immediately below the <section/> are displayed (FIG. 6). However, up until the time the zoom factor reaches 0.1, SecVideo appears as a static image of frame 0.

If Chapter is further zoomed into at this state, the zoom factor of the Section, SecText, and SecVideo further increases and the font size of the <sentence/> become larger. Simultaneously, the size of the <video/> also increases. When the zoom factor of SecVideo reaches 0.4, the playback of frame 0 to frame 400 of SecVideo begins (see FIG. 7 showing the change in the resolution).

Zooming out from the screen shown in FIG. 7 produces the reverse effect of zooming in. That is, the Section, SecText, and SecVideo are zoomed out, producing the screen shown in FIG. 6. When the zoom factor of SecText and SecVideo becomes 0.1, the <sentence/> and the <video/> disappear from the screen, returning to the screen shown in FIG. 5. In other words, if an operation is carried out to forcefully return the display screen to the initial status, the display screen returns to the status shown in FIG. 5, irrespective of the current zoomed state.

The zoom description according to the present embodiment allows description of zoom propagation from one zoom object to another zoom object that is linked to the first zoom object, enabling natural zooming between the zoom objects. Thus, zoom-in/zoom-out can be performed sequentially from higher level to lower level, enabling simultaneous zooming of related media objects.

Example of Zoom Propagation when Zoom Factor Relation is a Negative Value

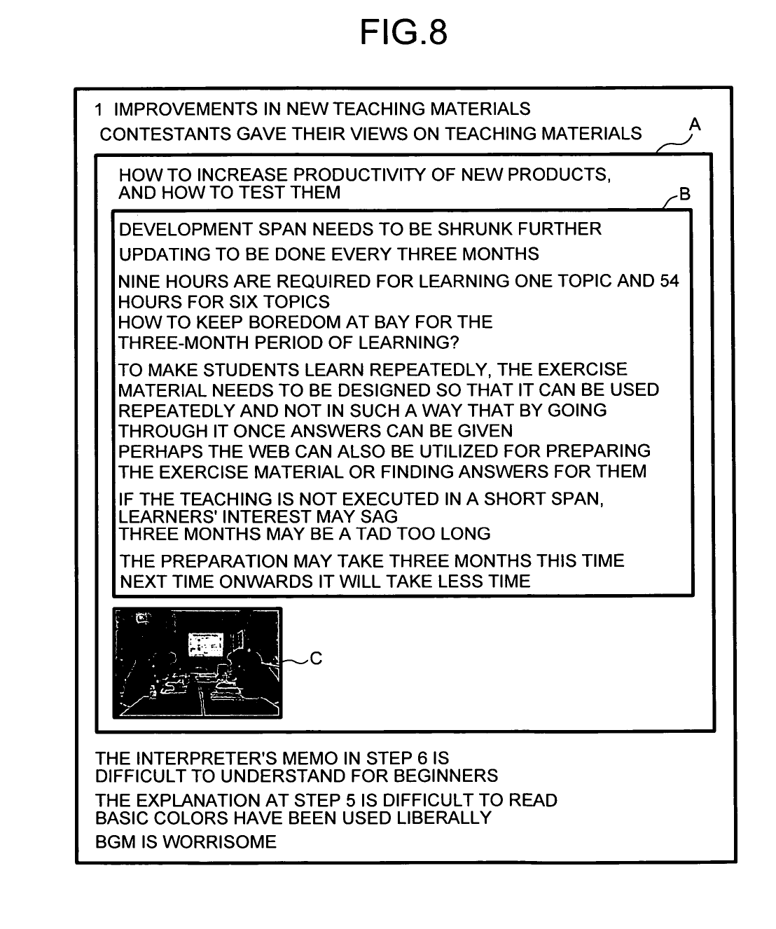

An example of zoom propagation when the zoom factor relation is a negative value is explained next. FIG. 8 is a schematic for explaining the screen transition that takes place when viewing multimedia contents. FIG. 8 is a schematic of a result of a zoom-in action on Object B of the multimedia contents shown in FIG. 7. Zooming in on Object B of the multimedia contents results in an increased font size of Object B and a decreased font size of Object C.

In the present embodiment, the following description is further added to the zoom description pertaining to the zoom action/behavior explained in a second embodiment of the present invention.

<propagation source=“SecText” select_s=“/chapter/section”
dest=“SecVideo” select_d=
“.” relation=“−0.5”/>
<propagation source=“SecVideo” select_s=“/chapter/section”
dest=“SecText” select_d=
“.” relation=“−0.5”/>

This zoom description indicates that if SecText is zoomed, SecVideo in the same location is also zoomed. Conversely, if SecVideo is zoomed, SecText in that location is also zoomed. In the description, in both the cases relation=” −0.5”. This indicates that if one object is zoomed into, the other object is zoomed out. If only SecText is zoomed into from the screen shown in FIG. 7, SecVideo is zoomed out (that is, a larger font size in the <sentence/>, and a smaller <video/> (see FIG. 8)).

Thus, opposite zooming is applied to linked zoom objects, realizing transition between different media.

According to the first embodiment, the display controller 32 reads the media object (text, still image, video image, audio object, etc.), which is an intended zoom object, and changes the display form of the media object, generating and displaying on the display unit 9 a revised contents organization based on the operation content of the user retrieved by the operation retrieving unit 31, the organization description pertaining to the display aspect of the contents, and the zoom description that describes the zoom action/behavior of each zoom object. The contents, constituting a collection of the media objects (text, still image, video image, audio object, etc.), dynamically change according to the operation content of the user, the organization description, and the zoom description. Consequently, the need for creating a fixed layout is obviated, making editing the contents easier. Further, the user is ensured a fair degree of freedom for viewing the contents.

The display description includes the organization description pertaining to the display aspect of the contents, and the zoom description that describes the zoom action/behavior of the media object (text, still image, video image, audio object, etc.). Thus, resolution of media objects can be changed by zooming, enabling the user to view more than one equally important media objects simultaneously by adjusting their zoom status to a preferred level and changing the display form of the contents according to user preference or view conditions. The zoom description is flexible enough to accommodate any content that is zoomable.

In the first embodiment, the contents viewing system is implemented on a client computer and a server computer. However, the contents viewing system according to the first embodiment can also be implemented on a stand-alone computer. In this case, the CPU 2 of a single computer implements the zoom-object storing unit 21, the contents storing unit 22, the operation retrieving unit 31 and the display controller 32, according to the contents viewing program running under the OS of the computer. A single computer can implement the contents viewing system in the other embodiments as well, described below.

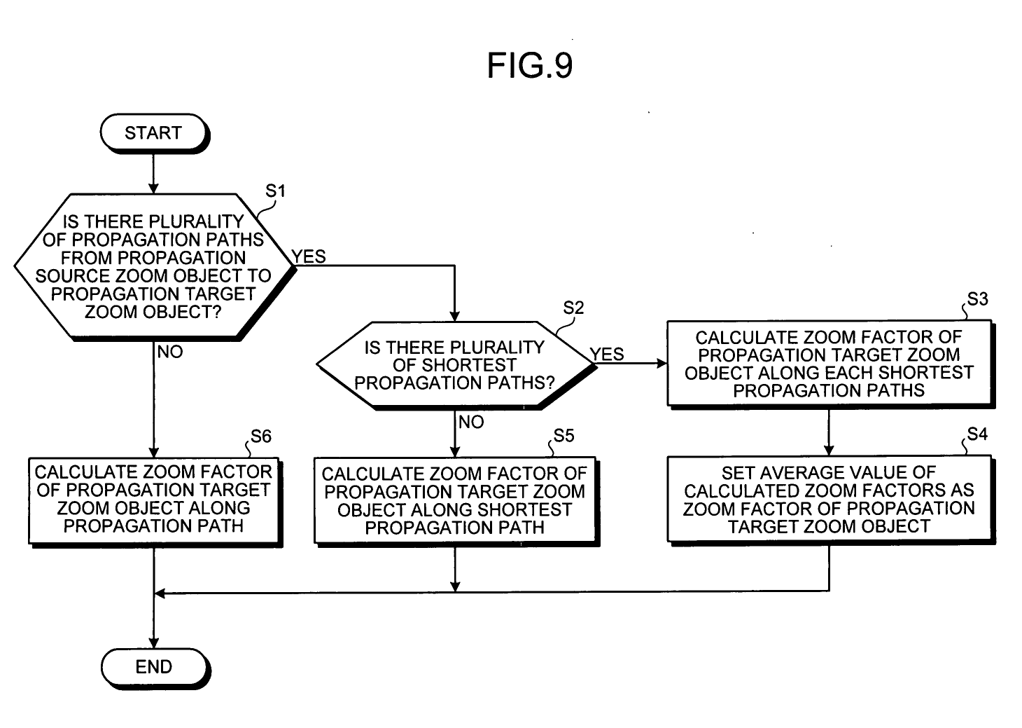

A second embodiment of the present invention is explained with reference to FIG. 9. The parts in the second embodiment that are identical to those of the first embodiment are assigned the same reference numeral and not described again.

The following zoom description is obtained by combining all the zoom descriptions for zoom propagation explained in the first embodiment.

Zoom description of contents

```
<template name=“Chapter” match=“/chapter”
initZoomFactor=“0.0”>
  <text select=“title, sentence”>
    <dispText zoomFactor=“0.0” fontSize=“12pt”/>
    <dispText zoomFactor=“1.0” fontSize=“14pt”/>
  </text>
</template>
<template name=“Section” match=“/chapter/section”
initZoomFactor=“0.0”>
  <text select=“title”>
    <dispText zoomFactor=“0.0” fontSize=“11pt”/>
    <dispText zoomFactor=“1.0” fontSize=“11pt”/>
  </text>
</template>
<template name= “SecText” match=“/chapter/section”
initZoomFactor=“0.0”>
  <text select=“sentence”>
    <dispText zoomFactor=“0.1” fontSize=“8pt”/>
    <dispText zoomFactor=“1.0” fontSize=“10pt”/>
  </text>
</template>
<template name= “SecVideo” match=“/chapter/section”
initZoomFactor=“0.0”>
  <video select=“video”>
    <dispVideo zoomFactor=“0.1” start=“0” end=“0”
videoSize=“20%”/>
    <dispVideo zoomFactor=“0.4” start=“0” end=“900”
videoSize=“50%”/>
    <dispVideo zoomFactor=“1.0” start=“0” end=“900”
videoSize=“100%”/>
  </video>
</emplate>
<propagation source=“Chapter” select_s=“/chapter”
dest=“Section” select_d=“section
” relation=“0.8”/>
<propagation source=“Section” select_s=“/chapter/section”
dest=“SecText” select_d=
“.” relation=“0.8”/>
<propagation source=“Section” select_s=“/chapter/section”
dest=“SecVideo” select_d=
“.” relation=“0.8”/>
<propagation source=“SecText” select_{—L s=“/chapter/section”}
dest=“SecVideo” select_d=
“.” relation=“−0.5”/>
<propagation source=“SecVideo” select_s=“/chapter/section”
dest=“SecText” select_d=
“.” relation=“−0.5”/>
```

In the second embodiment, upon zooming Chapter, zoom propagation follows two paths to reach SecText.

a. Chapter-Section-SecText

b. Chapter-Section-SecVideo-SecText

However, when there is a plurality of paths for zoom propagation, each path competes to calculate its own zoom factor for SecText.

To avoid any clash, in the present embodiment, the CPU 2, under the control of the contents viewing program running under the OS, selects a path of zoom propagation according to a stipulated rule.

FIG. 9 is a flowchart of a path selecting process. If it is determined that a plurality of propagation paths is available from the propagation source zoom object to the propagation destination zoom object (“Yes” at step S1), and that a plurality of shortest propagation paths is available (“Yes” at step S2), the CPU 2 calculates the zoom factor of the propagation destination zoom object along each of the shortest propagation paths (step S3). The CPU 2 then calculates an average of the calculated zoom factors and sets this value as the zoom factor of the propagation destination zoom object (step S4).

If it is determined that a plurality of propagation paths is available from the propagation source zoom object to the propagation destination zoom object (“Yes” at step Si), and that only a single shortest propagation path is available (“No” at step S2), the CPU 2 calculates the zoom factor of the propagation destination zoom object along the shortest propagation path (step S5).

If it is determined that only a single propagation path is available from the propagation source zoom object to the propagation destination zoom object (“No” at step S1), the CPU 2 calculates the zoom factor of the propagation destination zoom object along the available propagation path (step S6).

Thus, the clash for zoom factor calculation is avoided even when several propagation paths are available. The rule for selecting the propagation path can also be based on factors other than the length of the path.

An example is presented, wherein the CPU 2 calculates the zoom factor of the propagation destination zoom object along the shortest propagation path upon determining that a plurality of propagations paths is available from the propagation source zoom object to the propagation destination zoom object (“Yes” at step S1) and that only a single shortest propagation path is available (“No” at step S2).

In the zoom description given below, some parameters in the zoom description for zoom propagation described in the second embodiment have been changed.

Zoom description of contents
<template name=“Chapter” match=“/chapter”
initZoomFactor=“0.0”>

<text select=“title, sentence”>

<dispText zoomFactor=“0.0” fontSize=“12pt”/>
<dispText zoomFactor=“0.0” fontSize=“14pt”/>

</text>

</template>
<template name=“Section” match=“/chapter/section”
initZoomFactor=“0.0”>

<text select=“title”>

<dispText zoomFactor=“0.0” fontSize=“11pt”/>
<dispText zoomFactor=“1.0” fontSize=“11pt”/>

</text>

</template>
<template name= “SecText” match=“/chapter/section”
initZoomFactor=“0.0”>

<text select=“sentence”>

<dispText zoomFactor=“0.1” fontSize=“8pt”/>
<dispText zoomFactor=“1.0” fontSize=“10pt”/>

</text>

</template>
<template name= “SecVideo” match=“/chapter/section”
initZoomFactor=“1.0”>

<video select=“video”>

<dispVideo zoomFactor=“0.1” start=“0” end=“0”

videoSize=“20%”/>

<dispVideo zoomFactor=“0.4” start=“0” end=“900”

videoSize=“50%”/>

<dispVideo zoomFactor=“1.0” start=“0” end=“900”

videoSize=“100%”/>

</video>

</emplate>
<propagation source=“Chapter” select_s=“/chapter”
dest=“Section” select_d=“sec
tion” relation=“0.8”/>
<propagation source=“Section” select_s=“/chapter/section”
dest=“SecText” select
_d= “.” relation=“0.8”/>
<propagation source=“Section” select_s=“/chapter/section”
dest=“SecVideo” selec
t_d= “.” relation=“−0.8”/>
<propagation source=“SecText” select_s=“/chapter/section”
dest=“SecVideo” selec
t_d= “.” relation=“−0.5”/>
<propagation source=“SecVideo” select_s=“/chapter/section”
dest=“SecText” selec
t_d= “.” relation=“−0.5”/>

In the zoom description given above, SecVideo in the initial state has a zoom factor of 1.0. When the Section is zoomed in, Secvideo is zoomed out (SecText is simultaneously zoomed in). If SecText is directly selected and zoomed, SecVideo is zoomed out (or the reverse). Thus, both SecText and SecVideo under one Section cannot be simultaneously zoomed in or out, as the case may be.

Therefore, selecting and zooming a plurality of zoom objects is enabled. In other words, in the present embodiment both SecText and SecVideo under the Section are simultaneously selected and zoomed. This gives rise to unlimited propagation paths, some of which are given below.

a. Zooming of SecText itself

b. Zoom propagation from SecVideo-SecText

c. Zoom propagation from SecText-SecVideo-SecText

and so on. If the path “a.” is considered propagation stage 0, and the rule “calculation of the zoom factor of the propagation destination zoom object along the shortest propagation path (step S5)” is applied, the path “a.” is selected. The same can be applied to SecVideo as well. The resulting action is equivalent to zooming both SecText and SecVideo independently. Hence, both SecText and SecVideo can be zoomed in or out simultaneously.

Thus, selecting and zooming a plurality of zoom objects affords the user even more flexibility for zooming.

An example is presented wherein the CPU 2 determines that a plurality of propagations paths is available from the propagation source zoom object to the propagation destination zoom object (“Yes” at step S1) and that a plurality of shortest propagation paths is available (“Yes” at step S2), calculates the zoom factor along each of the available shortest paths (step S3), and sets the average value of the calculated zoom factors as the zoom factor of the propagation destination zoom object (step S4).

The display descriptions (organization description and zoom description) are given below.

```
Organization description of contents
<program>
  <scene>
    <text/>
    <video/>
  </scene>
  <scene>
    <text/>
    <video/>
  </scene>
</program>
Zoom description of contents
<template name=“Program” match=“/program”
initZoomFactor=“0.0”/>
<template name=“Scene” match=“/program/scene”
initZoomFactor=“0.0”/>
<template name=“AllText” match=“/program”
initZoomFactor=“0.0”/>
<template name=“AllVideo” match=“/program”
initZoomFactor=“0.0”/>
<template name=“Text” match=“/program/scene”
initZoomFactor=“0.0”>
  <text select=“text”>
    <dispText ....../>
  </text>
</template>
<template name=“Video” match=“/program/scene”
initZoomFactor=“0.0”>
  <video select=“video”>
    <dispVideo ....../>
  </text>
</template>
<propagation source=“Program” select_s=“/program”
dest=“Scene” select_d=“scene” relation=“1.0”/>
<propagation source=“Program” select_s=“/program”
dest=“AllText” select_d=“.”relation=“1.0”/>
<propagation source=“Program” select_s=“/program”
dest=“AllVideo” select_d=“.”relation=“1.0”/>
<propagation source=“Scene” select_s=“/program/scene”
dest=“Text” select_d=“.”relation=“0.8”/>
<propagation source=“Scene” select_s=“/program/scene”
dest=“Video” select_d=“.” relation=“0.8”/>
<propagation source=“AllText” select_s=“/program”
dest=“Text” select_d=“scene”relation=“0.6”/>
<propagation source=“AllVideo” select_s=“/program”
dest=“Video” select_d=“scene” relation=“0.6”/>
```

In the example presented above, upon zooming the Program, zooming is propagated to Scene, AllText, and AllVideo. From Scene, zooming is propagated to individual Text and Video under the Scene. From AllText, zooming is simultaneously propagated to all Text objects within the Program. Similarly, from AllVideo, zooming is simultaneously propagated to all Video objects within the Program. Thus, the following two paths are the possible paths from the Program to Text.

a. Program-Scene-Text

b. Program-AllText-Text

However, in the example presented above, since both the propagation paths are of the same length, the shortest propagation path rule cannot be applied. Hence, the rule “calculate zoom factors along the shortest propagation paths (step S3), and set the average value of the calculated zoom factors as the zoom factor of the propagation destination zoom object (step S4) is applied. Thus the zoom factor of the Text is determined based on the result of calculation of the zoom factors for each of the paths.

In this example, if the Program is zoomed by a zoom factor of +0.6 from the initial state, both Scene and All text are zoomed by the same zoom factor, that is, +0.6 (as relation=“1.0”). As the relation=“0.8” from Scene to Text, Text is zoomed by a zoom factor of +0.48. Similarly, as the relation=“0.6” from AllText to Text, Text is zoomed by a zoom factor of +0.36.

Therefore if the rule stipulates that average rule be applied, then Text is zoomed by a zoom factor of +42 (which is an average of +0.48 and +036). However, if the rule stipulates that the maximum value be applied, the zoom factor of +0.48 is applied to Text. If the rule stipulates that the minimum value be applied, the zoom factor of +0.36 is applied to Text.

Thus, when a plurality of propagation paths is available and a single propagation path cannot be arrived at even by applying the propagation path selection rule, zoom factor can still be set uniquely. The rule for setting zoom factor can include conditions other than setting an average value, maximum value, or minimum value.

A third embodiment of the present invention is explained next. The parts in the third embodiment that are identical to those in the first and second embodiments are assigned the same reference numerals.

The first and second embodiments presuppose that the organization description of the contents is preset. However, by using a template zoom description, zooming can be applied to contents for which organization descriptions are dynamically created. A search result is a good example where a template can be applied. When a database described in XML is queried, the search result displayed in the form of a list will depend upon the query. Hence the contents structure for the search result cannot be preset. However, a template zoom description enables zooming of any search result.

For example, let us suppose that a picture database has stored in it the following organization description.

Organization description of contents

```
<data>
  <lang>Japanese</lang>
  <caption>Caption1</caption>
  <image>Image1.jpg</image>
</data>
<data>
  <lang>Japanese</lang>
  <caption>Caption2</caption>
  <image>Image2.jpg</image>
</data>
<data>
  <lang>English</lang>
  <caption>Caption3</caption>
  <image>Image3.jpg</image>
</data>
<data>
  <lang>Japanese</lang>
  <caption>Caption4</caption>
  <image>Image4.jpg</image>
</data>
<data>
  <lang>English</lang>
    <caption>Caption5</caption>
  <image>Image5.jpg</image>
</data>
<data>
  <lang>Japanese</lang>
  <caption>Caption6</caption>
  <image>Image6.jpg</image>
</data>
```

<lang/> refers to the language in which the caption is described, <caption/> refers to the caption of the picture, and <image/> refers to the picture file name.

Let us suppose that the following zoom description is already provided.

Zoom description of contents

```
<template name=“Result” match=“/searchResult”
initZoomFactor=“0.0”/>
<template name=“Image” match=“/searchResult/data”
initZoomFactor=“0.0>
  <text select=“caption”>
    <dispText zoomFactor=“0.0” fontSize=“8pt”/>
    <dispText zoomFactor=“1.0” fontSize=“10pt”/>
  </text>
  <img select=“image”>
    <dispImg zoomFactor=“0.0” imgtSize=“0%”/>
    <dispImg zoomFactor=“1.0” imgtSize=“100%”/>
  </img>
</template>
<propagation source=“Result” select_s=“/searchResult”
dest=“Image” select_d=
“image” relation=“1.0”/>
```

Let us suppose that the user queries the data for “all data for which the caption is in Japanese”. The following organization description 1 is created as a result of the query.

Organization description 1 of contents

```
<searchResult>
<data>
  <lang>Japanese</lang>
  <caption>Caption1</caption>
  <image>Image1.jpg</image>
</data>
<data>
  <lang>Japanese</lang>
  <caption>Caption2</caption>
  <image>Image2.jpg</image>
</data>
<data>
  <lang>Japanese</lang>
  <caption>Caption4</caption>
  <image>Image4.jpg</image>
</data>
<data>
  <lang>Japanese</lang>
  <caption>Caption6</caption>
  <image>Image6.jpg</image>
</data>
</searchResult>
```

If the earlier zoom description is applied to the organization description, the search result is zoomed. In other words, in the initial state only the caption list is displayed. As the caption is zoomed, the caption font size increases as well as the picture image appears, gradually becoming bigger.

If the user queries the database for “all data for which the caption is in English”, the following organization description 2 is created.

Organization description 2 of contents

```
<searchResult>
    <data>
  <lang>English</lang>
  <caption>Caption3</caption>
  <image>Image3.jpg</image>
</data>
<data>
  <lang>English</lang>
  <caption>Caption5</caption>
  <image>Image5.jpg</image>
</data>
</searchResult>
```

The earlier zoom description can be applied to the organization description 2 as well to zoom the search result.

Thus, zooming can also be performed for objects, such as search results, whose organization description change dynamically.

The database being searched can be on the server computer or on a local machine. Query can be formulated in text, still images, video images, audio data, etc. Any method can be used for selecting data from the database that match the query.

According to the above embodiments, a display controller reads an object, which is an intended zoom object, and changes the display form of the media object, generating and displaying on the display unit 9 a revised. contents organization based on an operation content of a user retrieved by a operation retrieving unit, an organization description pertaining to a display aspect of the contents, and a zoom description that describes the zoom action/behavior of each zoom object. The contents, constituting a collection of zoom objects, dynamically change according to the operation content of the user, the organization description, and the zoom description. Consequently, the need for creating a fixed layout is obviated, making editing the contents easier. Further, the user is ensured a fair degree of freedom for viewing the contents.

Moreover, zoom action/behavior can be described for a specific zoom object included in the organization description.

Furthermore, a common zoom action/behavior can be described as a template for all the zoom objects that have a similar structure.

Moreover, the resolution or the media transition of the zoom object, which can be a single media object or a combination of plurality of media objects, can be realized by zooming. Consequently, the user can view more than one equally important object simultaneously by adjusting their zoom status to a preferred level and changing the display form of the contents according to user preference or view conditions.

Furthermore, the zoom action/behavior is controlled by a parameter that indicates the zoom level. Consequently, display form can be finely controlled.

Moreover, the zoom description allows description of zoom propagation from one zoom object to another zoom object that is linked to the first zoom object, enabling natural zooming between the zoom objects.

Furthermore, the zoom propagation between two zoom objects is controlled by a parameter indicating a relation of the zoom factors of the zoom objects. Consequently, the display form can be finely controlled.

Moreover, even if a plurality of propagation paths is available, zoom control can be accomplished without any clash in the selection of zoom factor.

Furthermore, when a plurality of propagation paths is available and a single propagation path cannot be arrived at even by applying the propagation path selection rule, zoom factor can still be set uniquely.

Moreover, a plurality of zoom objects can be simultaneously selected. Consequently, the user is afforded even more flexibility for zooming.

Furthermore, by application of a zoom description template, zooming can be applied even to contents that are dynamically generated by the organization description. For example, when a database described in XML is queried, the search result displayed in the form of a list will depend upon the query. Hence the contents structure for the search result cannot be preset. However, a template zoom description enables zooming of any search result.

Moreover, the objects that are potential zoom objects and that are constituent elements of contents are stored in a storage unit. The organization description and the zoom description are also stored in the storage unit, wherein the organization description pertains to a display aspect of the contents, and the zoom description distinguishes between the zoom objects and non-zoom objects, and describes zoom action/behavior for each of the zoom objects, the zoom description being independent from the organization description. The zoom object is read and its display form changed based on the organization description and the zoom description. Thus, the contents, constituting a collection of zoom objects, dynamically change according to the operation content of the user, the organization description, and the zoom description. Consequently, the need for creating a fixed layout is obviated, making editing the contents easier.

Moreover, zoom action/behavior can be described for a specific zoom object included in the organization description.

Furthermore, a common zoom action/behavior can be described as a template for all the zoom objects that have a similar structure.

Moreover, the resolution or the media transition of the zoom object, which can be a single media object or a combination of plurality of media objects, can be realized by zooming. Consequently, the user can view more than one equally important object simultaneously by adjusting their zoom status to a preferred level and changing the display form of the contents according to user preference or view conditions.

Furthermore, the zoom action/behavior is controlled by a parameter that indicates the zoom level. Consequently, the display form can be finely controlled.

Moreover, the zoom description allows description of zoom-propagation from one zoom object to another zoom object that is linked to the first zoom object, enabling natural zooming between the zoom objects.

Furthermore, the zoom propagation between two zoom objects is controlled by a parameter indicating a relation of the zoom factors of the zoom objects. Consequently, the display form can be finely controlled.

Moreover, even if a plurality of propagation paths is available, zoom control can be accomplished without any clash in the selection of zoom factor.

Furthermore, when a plurality of zoom propagation paths are available for selection based on the preset propagation path selection rule, the zoom factor of the propagation destination zoom object is determined by calculating the zoom factor for each zoom propagation path using the parameter and processing the calculated zoom factors by a preset rule.

Moreover, the objects, which are intended zoom objects, are read, their display forms changed, and displayed on the display unit as a revised contents organization based on the operation content of the user retrieved in an operation retrieval step, the organization description pertaining to the display form of the contents, and the zoom description that describes the zoom action/behavior for each zoom object. Thus, the contents, constituting a collection of zoom objects, dynamically change according to the operation content of the user, the organization description, and the zoom description. Consequently, the need for creating a fixed layout is obviated, making editing the contents easier. Further, the user is ensured a fair degree of freedom for viewing the contents.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A contents viewing system comprising:
a zoom-object storing unit that stores objects in a storage unit, the objects being potential zoom objects and constituent elements of contents, and the contents being elements of data;
a contents storing unit that stores an organization description and a zoom description in the storage unit, wherein the organization description pertains to a display aspect of the contents, and the zoom description distinguishes between the zoom objects and non-zoom objects, and describes zoom action/behavior for each of the zoom objects, the zoom description being independent from the organization description;
an operation retrieving unit that retrieves operation content; and
a display control unit that reads zoom object from the storage unit based on retrieved operation contents, the organization description and the zoom description in the storage unit, changes a display form of read zoom object to obtain contents to be displayed, and displays the contents to be displayed on a display unit.

2. The contents viewing system according to claim 1, wherein the zoom description in the storage unit directly specifies each zoom object in the storage unit and describes the zoom action/behavior for the zoom object.

3. The contents viewing system according to claim 1, wherein the zoom description specifies a pattern of the zoom objects and describes the zoom action/behavior for the pattern.

4. The contents viewing system according to claim 1, wherein the zoom object includes a single media object or a combination of a plurality of media objects.

5. The contents viewing system according to claim 1, further comprising:
a zoom level setting unit that sets a zoom level; and
a zoom operation/behavior controlling unit that controls the zoom operation/behavior based on set zoom level.

6. The contents viewing system according to claim 1, further comprising a zoom description creating unit that creates the zoom description based on a description of zoom propagation between zoom objects, zoom propagation being a phenomenon involving propagation of zooming from one zoom object to another zoom object linked to the zoom object.

7. The contents viewing system according to claim 6, further comprising a zoom factor setting unit that sets a zoom factor, and
wherein the zoom description creating unit changes the description of zoom propagation based on set zoom factor.

8. The contents viewing system according to claim 7, wherein when a plurality of zoom propagation paths are available for performing zoom propagation between two zoom objects, and the display control unit exerts control using the parameter of the zoom propagation path selected based on a preset propagation path selection rule.

9. The contents viewing system according to claim 8, wherein when a plurality of zoom propagation paths are available for selection based on the preset propagation path selection rule, the zoom factor setting unit sets a zoom factor of the propagation destination zoom object based on a zoom factor for each zoom propagation path using the parameter and processing the calculated zoom factors by a preset rule.

10. The contents viewing system according to claim 1, wherein zooming action can be performed by simultaneously selecting a plurality of zoom objects.

11. The contents viewing system according to claim 1, wherein the organization description dynamically generates contents, and the dynamically generated contents are displayed based on the zoom description.

12. A computer program product embodied on a computer-readable medium and comprising computer program codes that, when executed, causes a computer to perform:
storing objects in a storage unit, the objects being potential zoom objects and constituent elements of contents, and the contents being elements of data; and
storing an organization description and a zoom description in the storage unit, wherein the organization description pertains to a display aspect of the contents, and the zoom description distinguishes between the zoom objects and non-zoom objects, and describes zoom action/behavior for each of the zoom objects, the zoom description being independent from the organization description.

13. The computer program product according to claim 12, wherein the zoom description in the storage unit directly specifies each zoom object in the storage unit and describes the zoom action/behavior for the zoom object.

14. The computer program product according to claim 12, wherein the zoom description specifies a pattern of the zoom objects and describes the zoom action/behavior for the pattern.

15. The computer program product according to claim 12, wherein the zoom object includes a single media object or a combination of a plurality of media objects.

16. The computer program product according to claim 12, wherein the computer program further causes the computer to execute:
setting a zoom level; and
controlling the zoom operation/behavior based on set zoom level.

17. The computer program product according to claim 12, wherein the computer program further causes the computer to execute creating the zoom description based on a description of zoom propagation between zoom objects, zoom propagation being a phenomenon involving propagation of zooming from one zoom object to another zoom object linked to the zoom object.

18. The computer program product according to claim 17, wherein the computer program further causes the computer to execute setting unit a zoom factor, and
wherein the creating includes changing the description of zoom propagation based on set zoom factor.

19. A computer program product embodied on a computer-readable medium and comprising computer program codes that, when executed, causes a computer to perform:
retrieving operation content; and
reading zoom object from the storage unit based on retrieved operation contents, the organization description and the zoom description in the storage unit; and
changing a display form of read zoom object to obtain contents to be displayed, and displays the contents to be displayed on a display unit,
wherein when a plurality of zoom propagation paths are available for performing zoom propagation between two zoom objects, the changing includes exerting control using a parameter of the zoom propagation path selected based on a preset propagation path selection rule.

20. The computer program product according to claim 19, wherein when a plurality of zoom propagation paths are available for selection based on the preset propagation path selection rule, the computer program further causes the computer to execute setting a zoom factor of the propagation destination zoom object based on a zoom factor for each zoom propagation path using the parameter and processing the calculated zoom factors by a preset rule.

21. A contents viewing method comprising:
storing objects in a storage unit, the objects being potential zoom objects and constituent elements of contents, and the contents being elements of data;
storing an organization description and a zoom description in the storage unit, wherein the organization description pertains to a display aspect of the contents, and the zoom description distinguishes between the zoom objects and non-zoom objects, and describes zoom action/behavior for each of the zoom objects, the zoom description being independent from the organization description;
retrieving operation content;
reading zoom object from the storage unit based on retrieved operation contents, the organization description and the zoom description in the storage unit; and
changing a display form of read zoom object to obtain contents to be displayed, and displays the contents to be displayed on a display unit.
